(19) United States
(12) Patent Application Publication
(10) Pub. No.: US 2023/0010098 A1
(43) Pub. Date: Jan. 12, 2023

(54) NETWORK ACCESS VIA DEVICE IDENTIFIER

(71) Applicant: Hewlett-Packard Development Company, L.P., Spring, TX (US)

(72) Inventors: Tadeu de Sousa Marchese, Porto Alegre (BR); Juliano Francisco Cagnini Ciocari, Porto Alegre (BR)

(73) Assignee: Hewlett-Packard Development Company, L.P., Spring, TX (US)

(21) Appl. No.: 17/783,053

(22) PCT Filed: Jan. 7, 2020
(86) PCT No.: PCT/US2020/012626

§ 371 Date: Jun. 7, 2022

(51) Int. Cl. H04W 12/08; H04W 12/69

(52) U.S. Cl. CPC H04W 12/08; H04W 12/69

(57) ABSTRACT

An example computing device includes a processor to: determine a device identifier of a client device and connection information of a network; request access to the network using the device identifier of the computing device and the connection information; and in response to determining the request is successful, release the device identifier.

### BACKGROUND

A captive portal is an approach to control access to a network. When a network employs a captive portal, a device trying to gain access to the network is first directed to a landing page where conditions to network access are presented. For example, the conditions may include authentication, acceptance to a network use policy, etc. Once the device satisfies the conditions, the device may be registered to the network and may be granted access to the network.

### BRIEF DESCRIPTION OF THE DRAWINGS

Some examples of the present application are described with respect to the following figures:

FIG. 1 illustrates a system where network access for a client device is enabled by a companion device, according to an example;

FIG. 2 illustrates an operation flow at a client device and a companion device to enable the client device to access a network via the companion device, according to an example;

FIG. 3 illustrates an operation flow at a client device and a companion device to enable the client device to access a network via the companion device, according to another example;

FIG. 4 illustrates a computing device to access a network via a companion device, according to an example;

FIG. 5 illustrates the computing device to enable network access for a client device, according to an example;

FIG. 6 illustrates a computing device to access a network via a companion device, according to another example; and

FIG. 7 illustrates a computing device to enable network access for a client device, according to another example.

### DETAILED DESCRIPTION

When a computing device, such as a laptop computer, is trying to gain access to a network that employs a captive portal, the computing device may present the landing page to a user of the computing device so that the user may register the computing device for access (e.g., by filling out requested information, agreeing to a use policy, etc.). However, in some situations, a computing device may temporarily lack the functionality to interact with the captive portal. For example, when a computing device is in a pre-boot environment, the computing device may not be able to execute a web browser application to load the captive portal. Thus, the computing device may not be able to gain access to the network while in the pre-boot environment.

Examples described herein provide an approach to enable a computing device to gain access to a network that employs a captive portal while the computing device has a reduced set of features (e.g., while the computing device is in the pre-boot environment). In an example, a computing device may include a processor to: determine a device identifier of a client device and connection information of a network; request access to the network using the device identifier of the computing device and the connection information; and in response to determining the request is successful, release the device identifier.

In another example, a computing device may include a processor to: provide connection information of a network to a companion device; determine a device identifier of the companion device; access the network using the device identifier to perform an operation; and in response to a completion of the operation, release the device identifier.

In another example, a computing device may include a processor to: determine connection information of a network based on information from a client device; request access to the network using a device identifier of the computing device and the connection information; and in response to determining the request is successful, provide the device identifier to the client device. Thus, examples described herein may enable a computing device to facilitate another computing device to access a network that employs a captive portal.

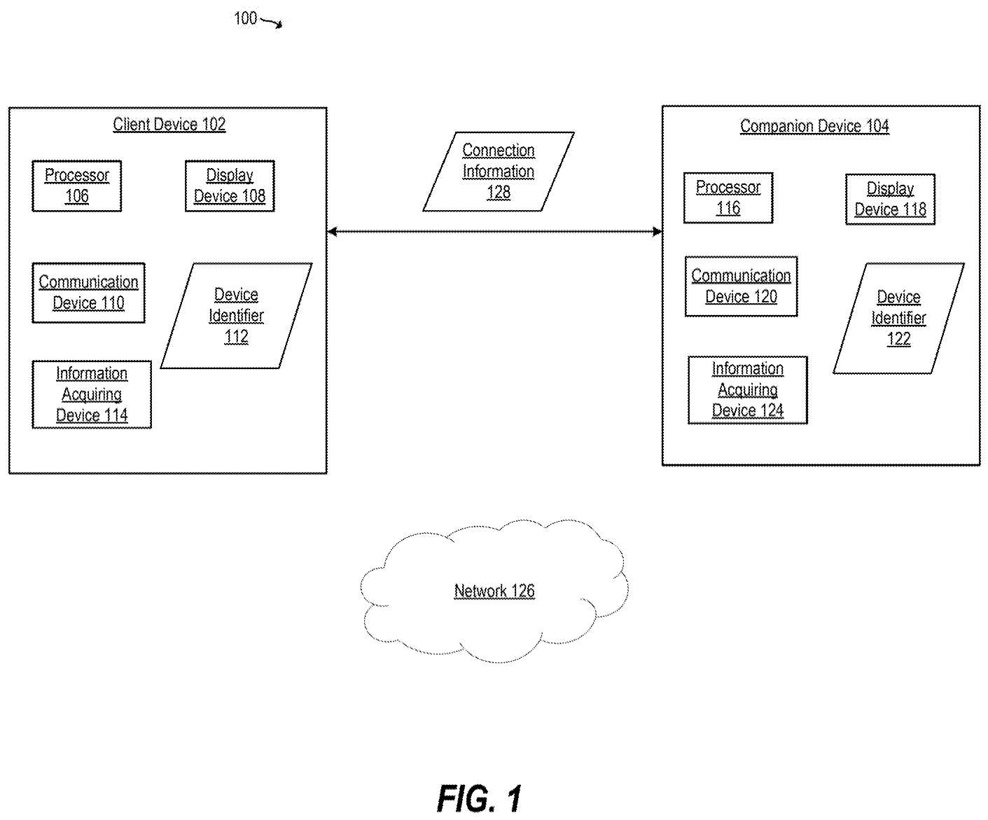

Turning to FIG. 1, FIG. 1 illustrates a system 100 where network access for a client device 102 is enabled by a companion device 104, according to an example.

As illustrated in FIG. 1, system 100 may include client device 102 and companion device 104. Client device 102 and companion device 104 may each be, for example, a web-based server, a local area network server, a cloud-based server, a laptop computer, a desktop computer, an all-in-one system, a tablet computing device, a mobile phone, an electronic book reader, or any other computing device suitable to access a network.

Client device 102 may include a processor 106, a display device 108, a communication device 110, a device identifier 112, and an information acquiring device 114. Companion device 104 may include a processor 116, a display device 118, a communication device 120, a device identifier 122, and an information acquiring device 124.

Processors 106 and 116 may control the operations of client device 102 and companion device 104, respectively. Processors 106 and 116 may each be a central processing unit (CPU), a semiconductor-based microprocessor, and/or other hardware devices suitable for retrieval and execution of instructions stored in a computer-readable storage medium.

Display devices 108 and 118 may each be implemented using a display panel (e.g., liquid crystal display, organic light-emitting diode, etc.) and associated electronics, such as a display controller. Communication devices 110 and 120 may each be circuitry (e.g., transmitter, receiver, antenna, etc.) that enable client device 102 and companion device 104 to transmit and/or receive data with another device or with a network. In some examples, communication devices 110 and 120 may implement the Institute of Electrical and Electronics Engineers (IEEE) 802.11 family of protocols so that client device 102 and companion device 104 may communicate with each other, other devices, a network (e.g., an access point, a router, a gateway, etc.) via radio waves. Communication devices 110 and 120 may also implement other wireless communication protocols, such as Bluetooth, near-field communication (NFC), etc. Communication devices 110 and 120 may also implemented wired communication protocols, such as the IEEE 802.3 protocol.

Information acquiring devices 114 and 124 may be any hardware and/or machine executable instructions that obtain data or information from an entity external to client device 102 and companion device 104, respectively. In some examples, an information acquiring device may be an image capturing device, such as a camera. In some examples, an information acquiring device may be a sound capturing device, such as a microphone. In some example, an information acquiring device may be an input device, such as a keyboard, a click pad, a mouse, etc. In some examples, an information acquiring device may be a communication device as described above. In some examples, an information acquiring device may be memory.

Device identifier 112 and device identifier 122 may each be a value that unique identifies client device 102 and companion device 104 from other devices, respectively. In some examples, device identifier 112 may be implemented as a media access control (MAC) address of communication device 110. Device identifier 122 may be a MAC address of communication device 120. Each MAC address may be assigned to respective communication device 110 and communication device 120 during manufacturing. In some examples, device identifiers 112 and 122 may be implemented as globally unique identifiers (GUIDs) or universally unique identifiers (UUIDs). In some examples, device identifiers 112 and 122 may be implemented as respective name of client device 102 and companion device 104 (e.g., device name, network device name, etc.).

As described in more detail below, in some examples, companion device 104 may enable client device 102 to access a network 126 that employs a captive portal via the use of device identifier 112 and connection information 128 of network 126. In some examples, companion device 104 may enable client device 102 to access network 126 via the use of device identifier 122 and connection information 128. As used herein, connection information 128 may include a name of a network (e.g., SSID), a network password, characteristic of a network (e.g., authentication method the network employs), channel used by a network, and any other information that enables a device to connect to a network.

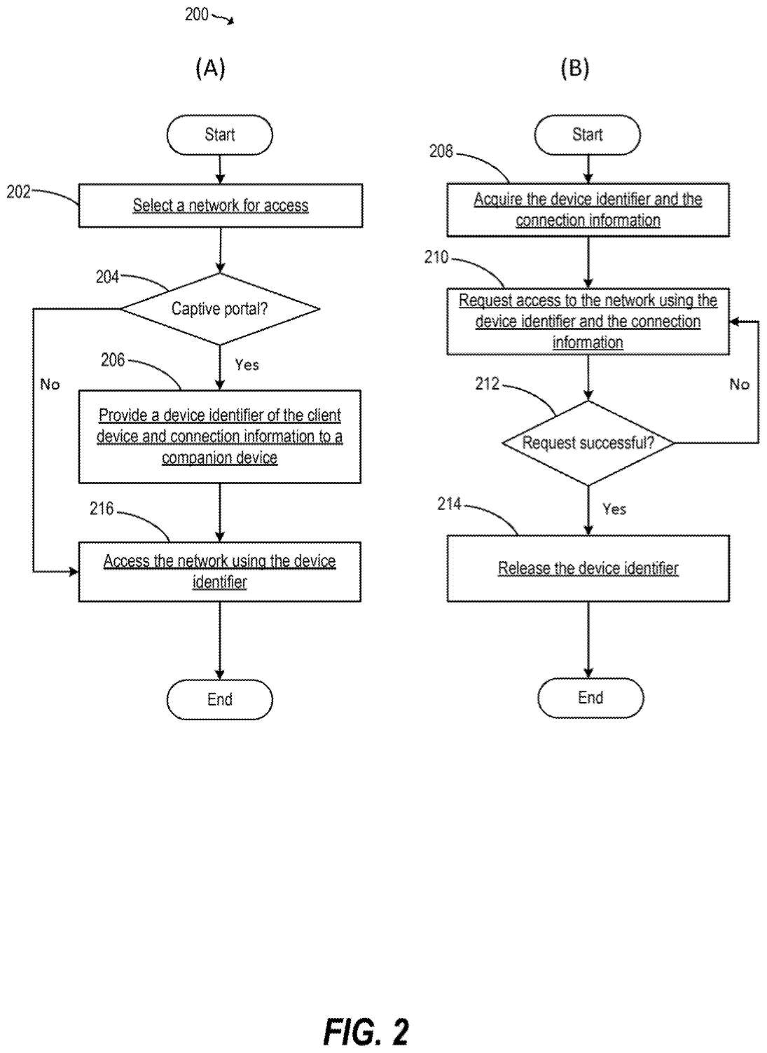

FIG. 2 illustrates operation flow 200 at client device 102 and companion device 104 to enable client device 102 to access network 126 via companion device 104, according to an example. Operations at client device 102 may be represented by column A and operations at companion device 104 may be represented by column B.

Client device 102 may determine that network access is needed and may select a network for access, at 202. For example, client device 102 may be performing an operating system recovery operation. A basic input/output system (BIOS) of client device 102 may generate a pre-boot environment to carry out the operating system recovery operation. As part of the operation, client device 102 may download an operating system image from a remote server. Thus, client device 102 may need network access to download the image from the server.

Client device 102 may use communication device 110 to detect networks available for connection, at 202. For example, communication device 110 may scan for service set identifiers of different wireless networks. Client device 102 may present a list of available networks to a user of client device 102 via display device 108. In response to receiving a selection of a particular network, client device 102 may determine if the particular network employs a captive portal, at 204. For example, network 126 may be selected. To determine if network 126 employs a captive portal, client device 102 may connect to network 126 and try to reach a particular web address, such as a universal resource locator (URL). If network 126 does not have a captive portal, an expected result may be returned. If network 126 employs a captive portal, a result different from the expected result may be returned.

In response to a determination that network 126 does not employ a captive portal, client device 102 may access network 126, at 216. In response to a determination that network 126 employs a captive portal, client device 102 may provide device identifier 112 and connection information 128 to companion device 104, at 206. Companion device 104 may acquire device identifier 112 and connection information 128 from client device 102, at 208. Examples of client device 102 providing device identifier 112 and connection information 128 and companion device 104 acquiring device identifier 112 and connection information 128 are described in more detail below.

In some examples, client device 102 may provide device identifier 112 and connection information 128 visually by displaying device identifier 112 and connection information 128 on display device 108. Client device 102 may display device identifier 112 and connection information 128 as encoded information on display device 108. In some examples, client device 102 may encode device identifier 112 and connection information 128 to a linear dimensional barcode. In some examples, client device 102 may encode device identifier 112 and connection information 128 to a matrix barcode, such as a quick response code. Once encoded, client device 102 may display the encoded information representing device identifier 112 and connection information 128 on display device 108.

Companion device 104 may use information acquiring device 124 to acquire device identifier 112 and connection information 128 by. For example, information acquiring device 124 may be implemented as an image capturing device, such as a camera. The image capturing device may scan the encoded information to acquire the encoded information. companion device 104 may decode the encoded information to determine device identifier 112 and connection information 128.

In some examples, client device 102 may provide device identifier 112 and connection information 128 to companion device 104 by using sound. For example, client device 102 may read out device identifier 112 and connection information 128 via a speaker (not shown in the FIGs). Information acquiring device 124 may be implemented as a sound capturing device, such as a microphone. The microphone may capture the sound and companion device 104 may determine device identifier 112 and connection information 128 by performing sound decoding on the captured sound. Alternatively, a user of client device 102 may write down the output sound and enter device identifier 112 and connection information 128 via an input device of client device 102.

In some examples, client device 102 may provide device identifier 112 and connection information 128 to companion device 104 by radio wave transmission. For example, client device 102 may transmit device identifier 112 and connection information 128 to companion device 104 to companion device 104 using communication device 110. Different protocols may be used, such as Bluetooth, NFC, etc. Information acquiring device 124 may be implemented using communication device 120. Companion device 104 may determine device identifier 112 and connection information 128 based on the received radio waves.

In some examples, client device 102 may provide device identifier 112 and connection information 128 separately and/or in different manners. For example, client device 102 may provide device identifier 112 visually as a barcode while providing connection information 128 via radio waves.

In response to determining device identifier 112 and connection information 128, companion device 104 may request access to network 126 using device identifier 112 and connection information 128. Companion device 104 may replace device identifier 122 with device identifier 112. For example, device identifier 112 may have a first value, such as E1-E2-E3-E4. and device identifier 122 may have a second value, such as A1-A2-A3-A4. In response to determining device identifier 112, companion device 104 may change the value of device identifier 122 from the second value (A1-A2-A3-A4) to the first value (E1-E2-E3-E4). Thus, the current device identifier of companion device 104 may be set to device identifier 112. By replacing device identifier 122 with device identifier 112, companion device 104 may authenticate and/or register for access to network 126 on behalf of client device 102.

Companion device 104 may also determine how to connect to network 126 using connection information 128. Once connected to network 126, a captive portal may be loaded and shown on display device 118. A user of companion device 104 may enter information via an input device (not shown in FIG. 1) of companion device 104 to satisfy the requirements of captive portal. For example, the user may enter credential information for authentication and may provide input to indicate the use policy is agreed to.

Companion device 104 may request access to network 126 by transmitting a request to an access server of network 126 (e.g., a gateway), at 210. The request may include information requested by the captive portal and device identifier 112. In response to determining that the request has satisfied the captive portal, the access server may grant network access to a device having device identifier 112. The access server may register device identifier 112 as approved device identifier. Thus, a device having device identifier 112 may subsequently access network 126 directly without having to go through the captive portal.

Companion device 104 may determine if the request to access network 126 is successful, at 212. For example, companion device 104 may receive an indication from the access server to determine if the request is successful. In response to determining that the request to access network is not successful, companion device 104 may be re-directed back to the captive portal to request for access again, at 210.

In response to determining that the request to access network 126 is successful, companion device 104 may release device identifier 112, at 214. Companion device 104 may release device identifier 112 by changing the current device identifier of companion device 104 from device identifier 112 back to device identifier 122. For example, companion device 104 may change the value of device identifier 122 from the first value back to the second value.

By releasing device identifier 112, client device 102 may become the only device (between client device 102 and companion device 104) associated with device identifier 112. Client device 102 may then access network 126 using device identifier 112, at 216. In some examples, companion device 104 may inform client device 102 that device identifier 112 has been released to avoid client device 102 and companion device 104 both using the same device identifier to access network 126.

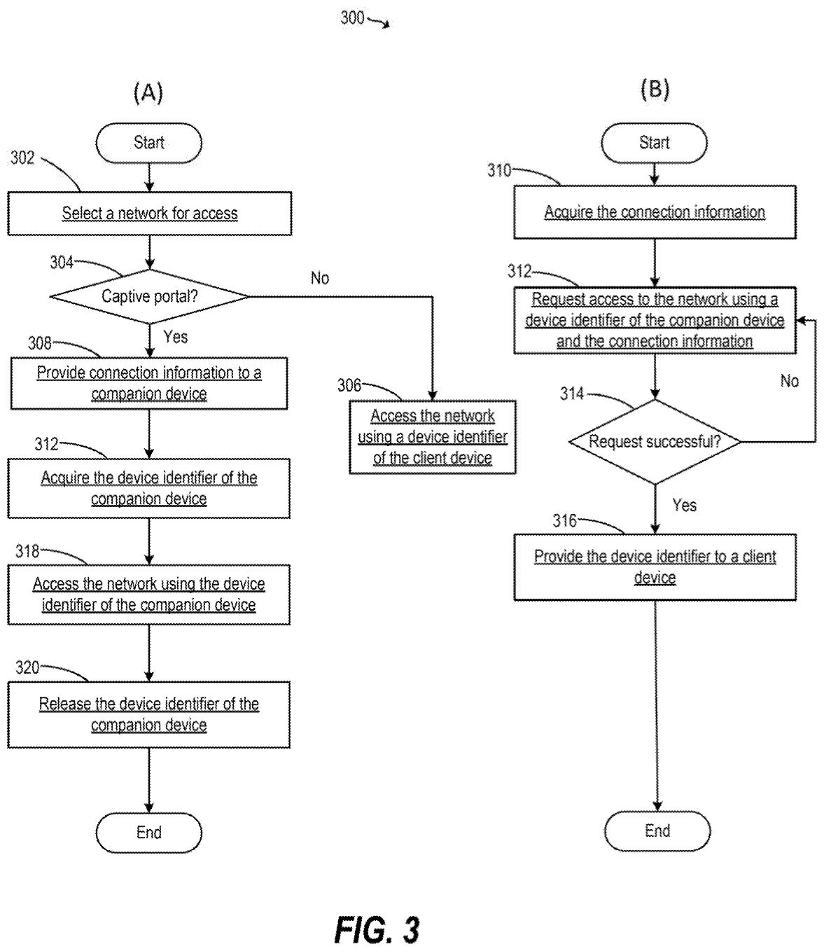

FIG. 3 illustrates an operation flow 300 at client device 102 and companion device 104 to enable client device 102 to access network 126 via companion device 104, according to another example. Operations at client device 102 may be represented by column A and operations at companion device 104 may be represented by column B.

Client device 102 may select network 126 for access, at 302. Client device 102 may determine if network 126 employs a captive portal, at 304. In response to a determination that network 126 does not employ a captive portal, client device 102 may access network 126 using device identifier 112, at 306.

In response to a determination that network 126 employs a captive portal, client device 102 may provide connection information 128 to companion device 104, at 308. Companion device 104 may acquire connection information 128, at 310. Examples of client device 102 providing connection information 128 to companion device 104 and companion device 104 acquiring connection information 128 are already described with reference to FIG. 2.

In response to acquiring connection information 128, companion device 104 may request access to network 126 using device identifier 122 and connection information 128, at 312. For example, companion device 104 may determine how to connect to network 126 using connection information 128. Once connected to network 126, a captive portal may be loaded and shown on display device 118. A user of companion device 104 may enter information via an input device (not shown in FIG. 1) of companion device 104 to satisfy the requirements of captive portal. For example, the user may enter credential information for authentication and may provide input to indicate the use policy is agreed to.

Companion device 104 may request access to network 126 by transmitting a request to the access server of network 126. The request may include information requested by the captive portal and device identifier 122. In response to determining that the request has satisfied the captive portal, the access server may grant network access to a device having device identifier 122. The access server may register device identifier 122 as approved device identifier. Thus, a device having device identifier 122 may subsequently access network 126 directly without having to go through the captive portal.

Companion device 104 may determine if the request for access is successful, at 314. In response to a determination that the request is not successful, companion device 104 may request for access again, at 312. In response to a determination that the request is successful, companion device 104 may provide device identifier 122 to client device 102, at 316. Client device 102 may acquire device identifier 122, at 318. Examples of companion device 104 providing device identifier 122 and client device 102 acquiring device identifier 122 are described in more detail below.

Similar to client device 102 providing device identifier 112 to companion device 104 as described with reference to FIG. 2, companion device 104 may use different ways to provide device identifier 122 to client device 102. In some examples, companion device 104 may provide device identifier 122 to client device 102 visually by displaying device identifier 122 on display device 118. Companion device 104 may display device identifier 122 as encoded information on display device 118. In some examples, companion device 104 may encode device identifier 122 to a numerical representation, such as a pin number. The pin number may be shown on display device 118.

Client device 102 may information acquiring device 114 to acquire device identifier 122. For example, information acquiring device 114 may be implemented as an input device of client device 102, such as a keyboard. Display device 108 may display a graphical user interface for a user of client device 102 to enter the pin number. When the user enters the pin number, client device 102 may determine device identifier 122 by decoding the pin number to obtain device identifier 122.

In some examples, companion device 104 may encode device identifier 122 to a barcode, such as a QR code. Companion device 104 may display the barcode on display device 118. Client device 102 may use a camera that implements information acquiring device 114 to scan the barcode. Once scanned, client device 102 may decode the barcode to determine device identifier 122.

In some examples, companion device 104 may provide device identifier 122 by using sound. Information acquiring device 114 may be implemented as a microphone to acquire the output sound from companion device 104. Client device 102 may decode the captured sound to determine device identifier 122.

In some examples, companion device 104 may provide identifier 122 by radio waves. Companion device 104 may transmit device identifier 122 to client device 102 as radio waves using a wireless communication protocol (e.g., Bluetooth, NFC, etc.). Client device 102 may acquire device identifier 122 by receiving radio waves representing device identifier using communication device 110, which may implement information acquiring device 114. Client device 102 may then determine device identifier 122 decoding the received radio waves.

In response to acquiring device identifier 122, client device 102 may replace device identifier 112 with device identifier 122. For example, client device 102 may change the value of device identifier 112 from the first value to the second value. Thus, the current device identifier of client device 102 may be set to device identifier 122. Client device 102 may then access network 126 using device identifier 122, at 318. By replacing device identifier 112 with device identifier 122, client device 102 may access network 126 by leveraging a registered device identifier, which is device identifier 122 in this case.

Client device 102 may access network 126 to perform an operation. For example, the operation may include downloading a file, such as downloading an operating system image for an operation system recovery operation, downloading an update file for the BIOS of client device 102, etc. In response to a completion of the operation, client device 102 may release device identifier 122 by replacing device identifier 122 with device identifier 112. Thus, the current device identifier of client device 102 may be set back to device identifier 112. In some examples, client device 102 may inform companion device 104 that device identifier 122 has been released to avoid client device 102 and companion device 104 both using the same device identifier to access network 126.

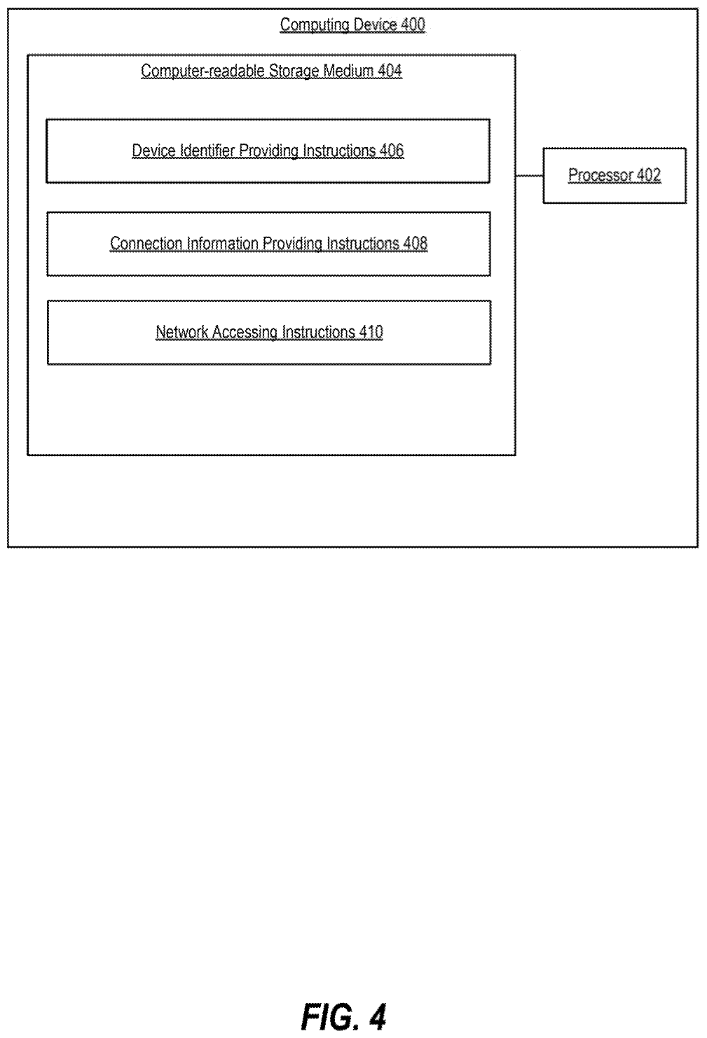

FIG. 4 illustrates a computing device 400 to access a network via a companion device, according to an example. Computing device 400 may implement client device 102 of FIG. 1. Computing device 400 may implement the operations of client device 102 in FIG. 2.

Computing device 400 may include a processor 402 and a computer-readable storage medium 404. Processor 402 may be a central processing unit (CPU), a semiconductor-based microprocessor, and/or other hardware devices suitable for retrieval and execution of instructions stored in computer-readable storage medium 404. Processor 402 may fetch, decode, and execute instructions 406, 408, and 410 to control operations of computing device 400. As an alternative or in addition to retrieving and executing instructions, processor 402 may include at least one electronic circuit that includes electronic components for performing the functionality of instructions 406, 408, 410, or a combination thereof.

Computer-readable storage medium 404 may be any electronic, magnetic, optical, or other physical storage device that contains or stores executable instructions. Thus, computer-readable storage medium 404 may be, for example, Random Access Memory (RAM), an Electrically Erasable Programmable Read-Only Memory (EEPROM), a storage device, an optical disc, etc. In some examples, storage medium 404 may be a non-transitory storage medium, where the term “non-transitory” does not encompass transitory propagating signals. Computer-readable storage medium 404 may be encoded with a series of processor executable instructions 406, 408, and 410.

Device identifier providing instructions 406 may provide a device identifier to another device. For example, referring to FIG. 2, client device 102 may provide device identifier 112 to companion device 104.

Connection information providing instructions 408 may provide connection information of a network to another device. For example, referring to FIG. 2, client device 102 may provide connection information 128 to companion device 104.

Network access instructions 410 may access using a device identifier. For example, referring to FIG. 2, client device 102 may access network 126 using device identifier 112.

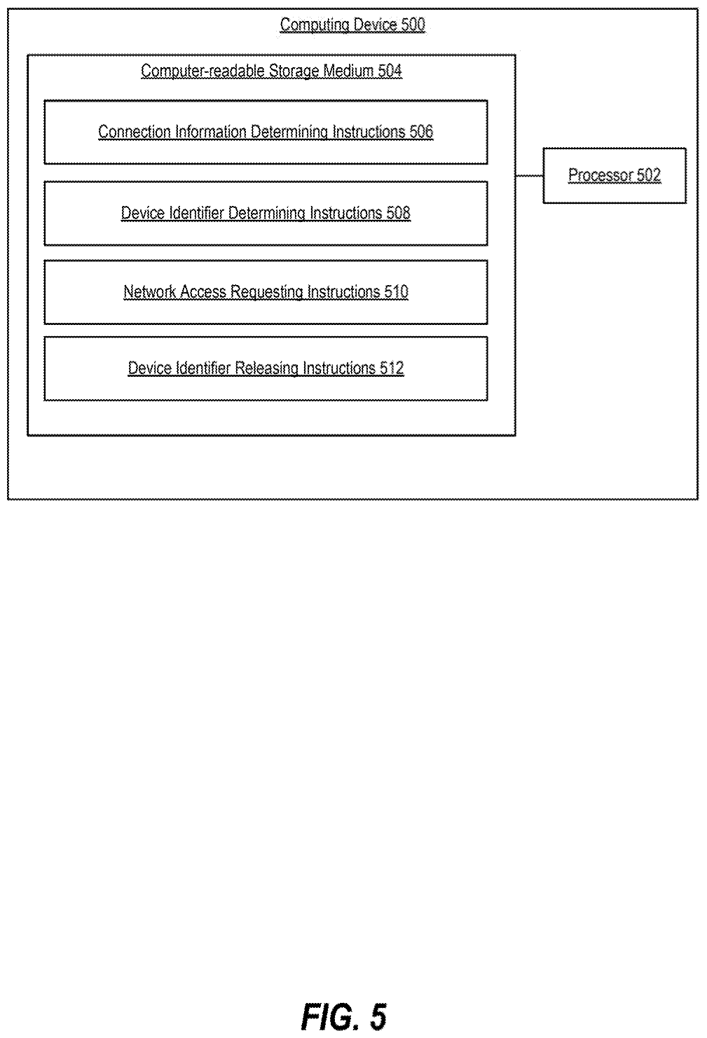

FIG. 5 illustrates the computing device 500 to enable network access for a client device, according to an example. Computing device 500 may implement companion device 104 of FIG. 1. Computing device 500 may perform the operations of companion device 104 in FIG. 2. Computing device 500 may include a processor 502 and a computer-readable storage medium 504. Processor 502 may be similar to processor 402 of FIG. 4. Computer-readable storage medium 504 may be similar to computer-readable storage medium 404 of FIG. 4. Computer-readable storage medium 504 may be encoded with instructions 506, 508, 510, and 512 to control operations of computing device 500.

Connection information determining instructions 506 may determine connection information of a network. For example, referring to FIG. 2, companion device 104 may determine connection information 128.

Device identifier determining instructions 508 may determine a device identifier of another device. For example, referring to FIG. 2, companion device 104 may determine device identifier 112 acquired from client device 102.

Network access requesting instructions 510 may request network access. For example, referring to FIG. 2, companion device 104 may request access to network 126 using device identifier 112.

Device identifier releasing instructions 512 may lease a device identifier. For example, referring to FIG. 2, companion device 104 may release device identifier 112.

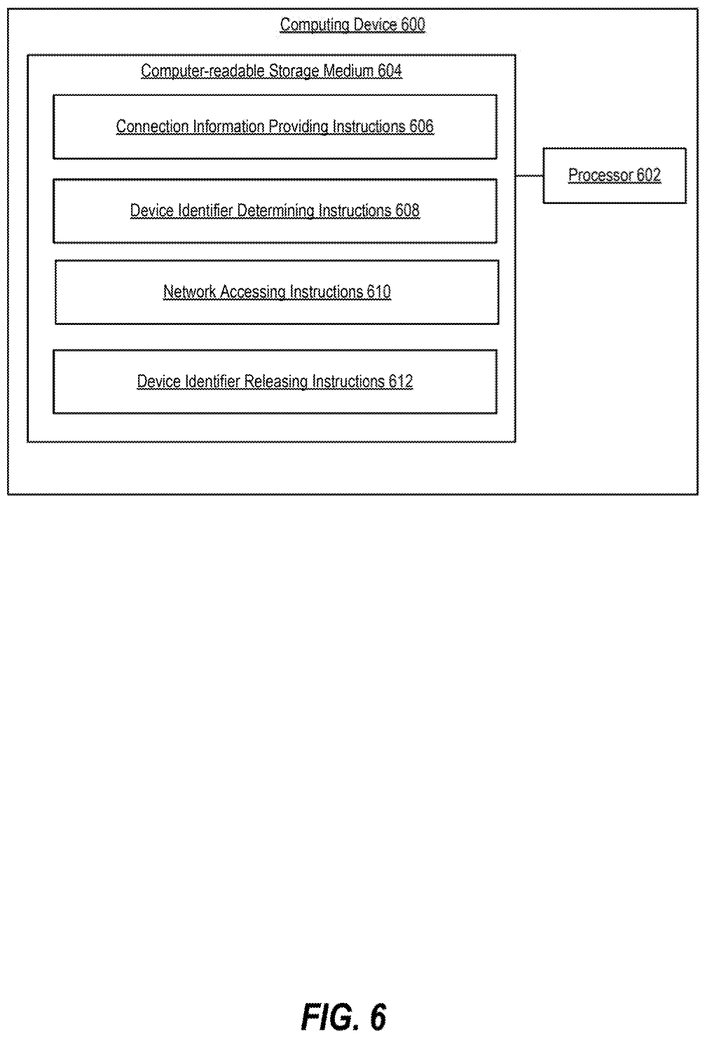

FIG. 6 illustrates a computing device 600 to access a network via a companion device, according to another example. Computing device 600 may implement client device 102 of FIG. 1. Computing device 600 may perform the operations of client device 102 in FIG. 3. Computing device 600 may include a processor 602 and a computer-readable storage medium 604. Processor 602 may be similar to processor 402 of FIG. 4. Computer-readable storage medium 604 may be similar to computer-readable storage medium 404 of FIG. 4. Computer-readable storage medium 604 may be encoded with instructions 606, 608, 610, and 612 to control operations of computing device 500.

Connection information providing instructions 606 may provide connection information of a network to another device. For example, referring to FIG. 3, client device 102 may provide connection information 128 to companion device 104.

Device identifier determining instructions 608 may determine a device identifier of another device. For example, referring to FIG. 3, client device 102 may determine device identifier 122 by computing a pin number representing device identifier 122.

Network accessing instructions 610 may access a network. For example, referring to FIG. 3, client device 102 may access network 126 using device identifier 122.

Device identifier releasing instructions 612 may release a device identifier. For example, referring to FIG. 3, client device 102 may release device identifier 122.

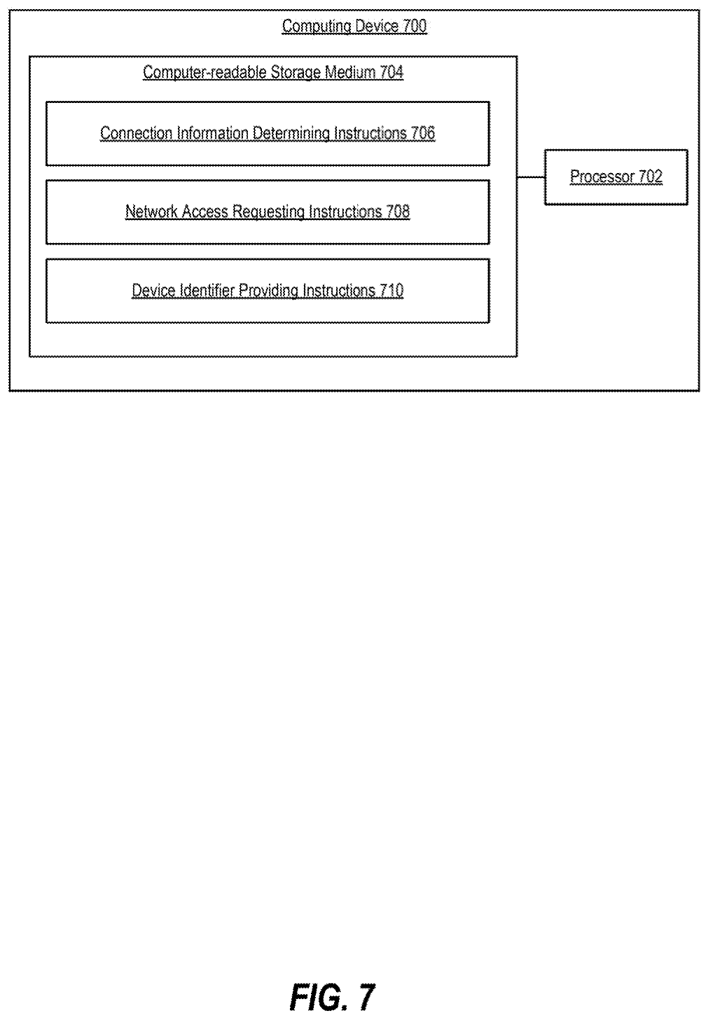

FIG. 7 illustrates a computing device 700 to enable network access for a client device, according to another example. Computing device 700 may implement companion device 104 of FIG. 1. Computing device 700 may perform operations of companion device 104 in FIG. 3. Computing device 700 may include a processor 702 and a computer-readable storage medium 704. Processor 702 may be similar to processor 402 of FIG. 4. Computer-readable storage medium 704 may be similar to computer-readable storage medium 404 of FIG. 4. Computer-readable storage medium 704 may be encoded with instructions 706, 708, and 710, and 612 to control operations of computing device 700.

Connection information determining instructions 706 may determine connection information of a network. For example, referring to FIG. 3, companion device 104 may determine connection information 128.

Network access requesting instructions 708 may request network access using a device identifier. For example, referring to FIG. 3, companion device 104 may request access to network 126 using device identifier 122.

Device identifier providing instructions 710 may provide a device identifier to another device. For example, referring to FIG. 3, companion device 104 may provide device identifier 122 to client device 102.

The use of “comprising”, “including” or “having” are synonymous and variations thereof herein are meant to be inclusive or open-ended and do not exclude additional unrecited elements or method steps.

What is claimed is:

1. A computing device comprising:
a processor to:
determine a device identifier of a client device and connection information of a network;
request access to the network using the device identifier of the computing device and the connection information; and
in response to determining the request is successful, release the device identifier.

2. The computing device of claim 1, wherein the device identifier of the client device corresponds to a first value, wherein the computing device has a device identifier corresponding to a second value, wherein the processor is further to:
in response to determining the device identifier of the client device, change the device identifier of the computing device from the second value to the first value; and
in response to gaining access to the network, change the device identifier of the computing device from the first value to the second value.

3. The computing device of claim 1, further comprising an image capturing device, wherein the processor is to acquire the device identifier of the client device and the connection information as encoded information via the image capturing device.

4. The computing device of claim 1, wherein the device identifier of the client device corresponds to a media access control address of the client device.

5. A computing device comprising:
a processor to:
provide connection information of a network to a companion device;
determine a device identifier of the companion device;
access the network using the device identifier to perform an operation; and
in response to a completion of the operation, release the device identifier.

6. The computing device of claim 5, further comprising a display device, wherein the processor is to provide the connection information via the display device.

7. The computing device of claim 6, wherein the display device is to display the connection information as a quick response (QR) code.

8. The computing device of claim 5, wherein the operation includes downloading a file.

9. The computing device of claim 5, wherein the computing device has a device identifier corresponding to a first value, wherein a device identifier of the companion device corresponds to a second value, and wherein the processor is further to:
in response to determining the device identifier of the companion device, change the device identifier of the computing device from the first value to the second value; and
in response to the completion of the operation, change the device identifier of the computing device from the second value to the first value.

10. The computing device of claim 5, wherein the processor is further to:
in response to determining the network employs a captive portal, provide the connection information to the companion device.

11. The computing device of claim 5, wherein the processor is further to:
acquire encoded information corresponding to the device identifier of the companion device; and
determine the device identifier based on the encoded information.

12. A computing device comprising:
a processor to:
determine connection information of a network based on information from a client device;
request access to the network using a device identifier of the computing device and the connection information; and
in response to determining the request is successful, provide the device identifier to the client device.

13. The computing device of claim 12, wherein the device identifier corresponds to a media access control address of the computing device.

14. The computing device of claim 12, further comprising a display device, wherein the processor is to direct the display device to display the device identifier as encoded information.

15. The computing device of claim 12, wherein the connection information includes a name of the network.
